(19) United States
(12) Patent Application Publication
(10) Pub. No.: US 2015/0237372 A1
(43) Pub. Date: Aug. 20, 2015

(54) METHOD AND APPARATUS FOR CODING MULTI-LAYER VIDEO AND METHOD AND APPARATUS FOR DECODING MULTI-LAYER VIDEO

(71) Applicant: SAMSUNG ELECTRONICS CO., LTD., Suwon-si Gyeonggi-do (KR)

(72) Inventors: Byeong-doo Choi, Siheung-si (KR); Jeong-hoon Park, Seoul (KR); Chan-yul Kim, Bucheon-si (KR)

(73) Assignee: SAMSUNG ELECTRONICS CO., LTD., Suwon-si (KR)

(21) Appl. No.: 14/434,294

(22) PCT Filed: Oct. 2, 2013
(86) PCT No.: PCT/KR2013/008829

§ 371 Date: Apr. 8, 2015

Related U.S. Application Data
(60) Provisional application No. 61/710,866, filed on Oct. 8, 2012.

(51) Int. Cl. H04N 19/597; H04N 19/169; H04N 19/187

(52) U.S. Cl. CPC H04N 19/597; H04N 19/187; H04N 19/1883; H04N 19/188

(57) ABSTRACT

Provided are methods of encoding and decoding multilayer video. The multilayer video encoding method includes: encoding an image sequence of each of a plurality of layers constituting multilayer video by using inter layer prediction; determining a reference layer referred to by the image sequence of each layer based on a result of the encoding; adding reference layer information of each layer to a first data unit comprising information commonly applied to the image sequence included in the multilayer video; and

when a reference layer referred to by the image sequence of each layer is changed at a predetermined point, adding change information of the reference layer to a second data unit.

### TECHNICAL FIELD

The present invention relates to methods and apparatuses for encoding and decoding scalable video and video configured as a multilayer such as multi-view video, and more particularly to, a high-level syntax structure for signaling inter layer prediction information of multilayer video.

### BACKGROUND ART

In general, image data is encoded by a codec according to a predetermined data compression standard, for example, the Moving Picture Expert Group (MPEG) standard, and then stored in an information storage medium in the form of a bitstream or transmitted via a communication channel.

Scalable video coding (SVC), as a video compression method, appropriately adjusts and transmits an amount of information in accordance with various communication networks and terminals. SVC provides a video encoding method of adaptively providing a service to various transmission networks and various receiving terminals by using a single video stream.

A multi-view video coding technology is widely used for 3D video coding because of the popularity of a 3D multimedia device and 3D multimedia content.

Such conventional SVC or multi-view video coding encodes video by using a limited encoding method based on a macroblock of a predetermined size.

### DETAILED DESCRIPTION OF THE INVENTION

### Technical Problem

The present invention provides signaling reference information between layers of multilayer video such as multi-view video and scalable video.

The present invention also provides skipping decoding of an image sequence of a layer unnecessary for decoding an image sequence of a predetermined layer based on reference information between layers of multilayer video.

### Technical Solution

According to exemplary embodiments of the present invention, when a reference layer is changed during inter layer prediction of multilayer video, change information of the reference layer is transmitted through a separate additional message.

### Advantageous Effects

According to exemplary embodiments of the present invention, when a reference relationship between layers of multilayer video is changed, a decoding side may be efficiently signaled whether to change the reference relationship and may skip decoding of another layer unnecessary for reproduction of a current layer.

### DESCRIPTION OF THE DRAWINGS

FIG. 1 is a block diagram of a multilayer video encoding apparatus according to an embodiment of the present invention;

FIG. 2 illustrates multilayer video according to an embodiment of the present invention;

FIG. 3 illustrates network abstraction layer (NAL) units including encoded data of multilayer video according to an embodiment of the present invention;

FIG. 4 illustrates an example of an inter layer prediction structure according to an embodiment of the present invention;

FIG. 5 illustrates an example of an inter layer prediction structure in multilayer video;

FIG. 6A illustrates a video parameter set (VPS) NAL unit according to an embodiment of the present invention, and FIG. 6B illustrates extension VPS information included in the VPS NAL unit according to an embodiment of the present invention;

FIG. 7 illustrates a supplemental enhancement information (SEI) message NAL unit according to an embodiment of the present invention;

FIG. 8 illustrates a SEI message NAL unit according to another embodiment of the present invention;

FIG. 9 illustrates a SEI message NAL unit according to another embodiment of the present invention;

FIG. 10 is a flowchart of a multilayer encoding method according to an embodiment of the present invention;

FIG. 11 is a block diagram of a multilayer video decoding apparatus according to an embodiment of the present invention;

FIG. 12 is a flowchart of a multilayer decoding method according to an embodiment of the present invention;

FIG. 13 is a block diagram of a video encoding apparatus based on coding units having a tree structure, according to an embodiment of the present invention;

FIG. 14 is a block diagram of a video decoding apparatus based on coding units having a tree structure, according to an embodiment of the present invention;

FIG. 15 is a diagram for describing a concept of coding units according to an embodiment of the present invention;

FIG. 16 is a block diagram of an image encoder based on coding units, according to an embodiment of the present invention;

FIG. 17 is a block diagram of an image decoder based on coding units, according to an embodiment of the present invention;

FIG. 18 is a diagram illustrating coding units according to depthspartitions, according to an embodiment of the present invention;

FIG. 19 is a diagram for describing a relationship between a coding unit and transformation units, according to an embodiment of the present invention;

FIG. 20 is a diagram for describing encoding information of coding units corresponding to a coded depth, according to an embodiment of the present invention;

FIG. 21 is a diagram of coding units according to depths according to an embodiment of the present invention;

FIGS. 22 through 24 are diagrams for describing a relationship between coding units, prediction units, and transformation units, according to an embodiment of the present invention; and

FIG. 25 is a diagram for describing a relationship between a coding unit, a prediction unit, and a transformation unit, according to the encoding mode information of Table 1.

### BEST MODE

According to an aspect of the present invention, there is provided a

According to another aspect of the present invention, there is provided a

According to another aspect of the present invention, there is provided a

According to another aspect of the present invention, there is provided a

### Mode of the Invention

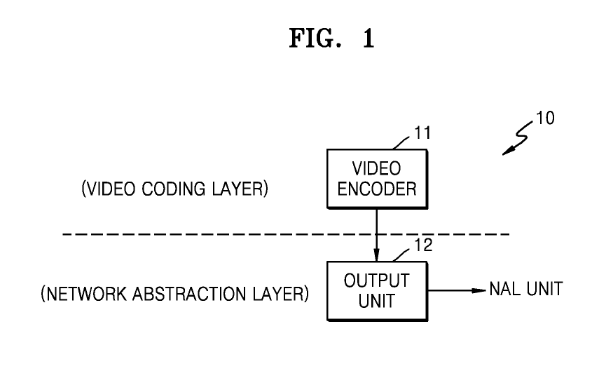

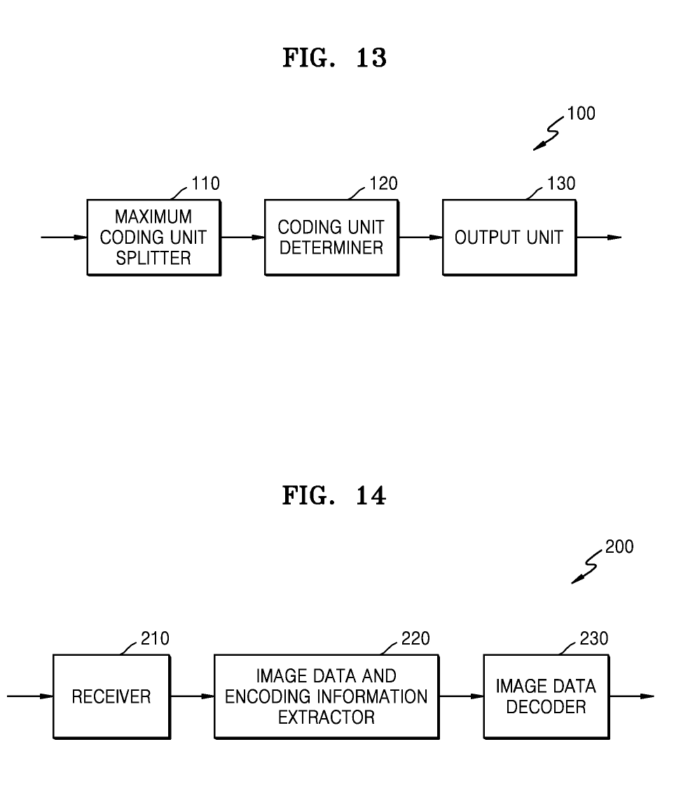

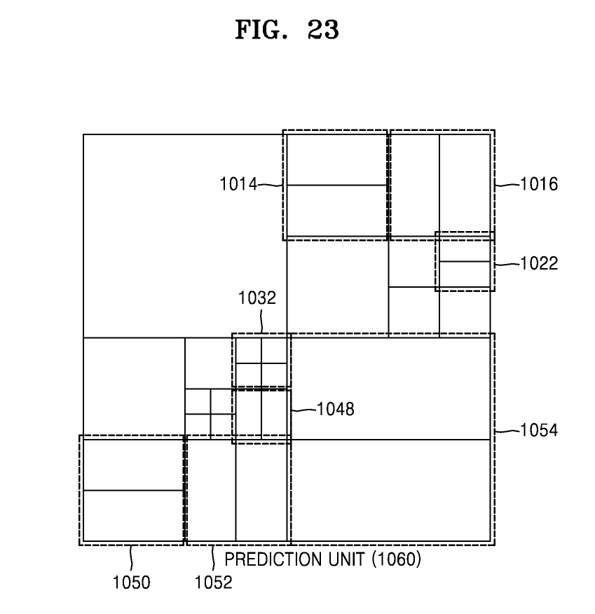

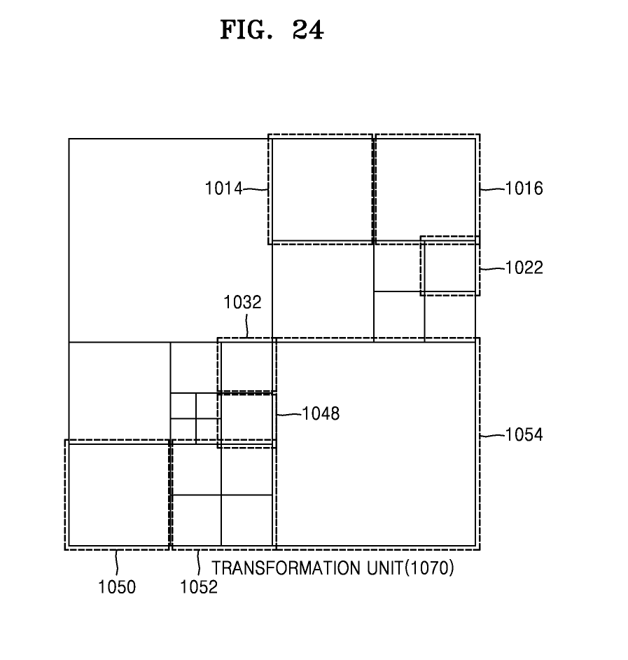

A multilayer video encoding method and a multilayer video decoding method according to embodiments of the present invention will be described with reference to FIGS. 1 through 12. A video encoding method and a video decoding method based on coding units having a tree structure, according to embodiments of the present invention, will be described with reference to FIGS. 13 through 25. Hereinafter, the term ‘image’ may refer to a still picture or a moving picture, that is, a video itself. A multilayer image may indicate a picture included in an image sequence of a plurality of views or a picture included in a base layer and an enhancement layer in scalable video.

FIG. 1 is a block diagram of a multilayer video encoding apparatus according to an embodiment of the present invention.

Referring to FIG. 1, the multilayer video encoding apparatus 10 according to an exemplary embodiment includes a video encoder 11 and an output unit 12.

The video encoder 11 receives and encodes multilayer video. The video encoder 11 corresponds to a video coding layer handling encoding of the input video itself.

The multilayer video encoding apparatus 10 according to an embodiment splits each picture included in the multilayer video into maximum coding units each having a maximum size, splits each of the split maximum coding units into coding units again, and encodes each picture based on the coding units. The coding units have a tree structure in which the maximum coding units are hierarchically split according to depths. The multilayer video encoding apparatus 10 performs prediction on the coding units by using a prediction unit and transforms the coding units by using a transformation unit. Video encoding and decoding methods based on coding units, prediction units, and transformation units according to the tree structure will be described with reference to FIGS. 13 through 25 later.

When the multilayer video is multi-view video, the video encoder 11 encodes each of n (where n is an integer) image sequences as one layer. When the multilayer video is scalable video, the video encoder 11 encodes each of an image sequence of a base layer and image sequences of an enhancement layer as one layer.

The multilayer video has a greater amount of data than that of single layer video. Thus, the video encoder 11 may perform prediction encoding by using a correlation between layers included in the multilayer video. In other words, the video encoder 11 may prediction encode each layer by referring to other layers.

As an example, the video encoder 11 may perform inter-view prediction for predicting additional view images with reference to base view images. The video encoder 11 may perform inter-view prediction for predicting other additional view images with reference to predetermined additional view images. Through inter-view prediction, a disparity indicating motion information between a current image and a reference image, and a residual that is a differential component between the current image and the reference image may be generated. Inter prediction and inter-view prediction may be performed based on a data unit such as a coding unit, a prediction unit, or a transformation unit as will be described later.

The video encoder 11 may perform prediction encoding within an image of a same layer, or transform and quantize a difference between a prediction value generated through inter-layer prediction and an original signal to perform encoding. Through such an encoding process in a video coding layer (VCL), the video encoder 11 outputs residual information related to a coding unit, prediction mode information, and additional is information related to prediction encoding of the coding unit. In particular, the video encoder 11 outputs reference layer information referred to by each layer when an image of a predetermined layer is prediction encoded with reference to an image of another layer through inter-layer prediction.

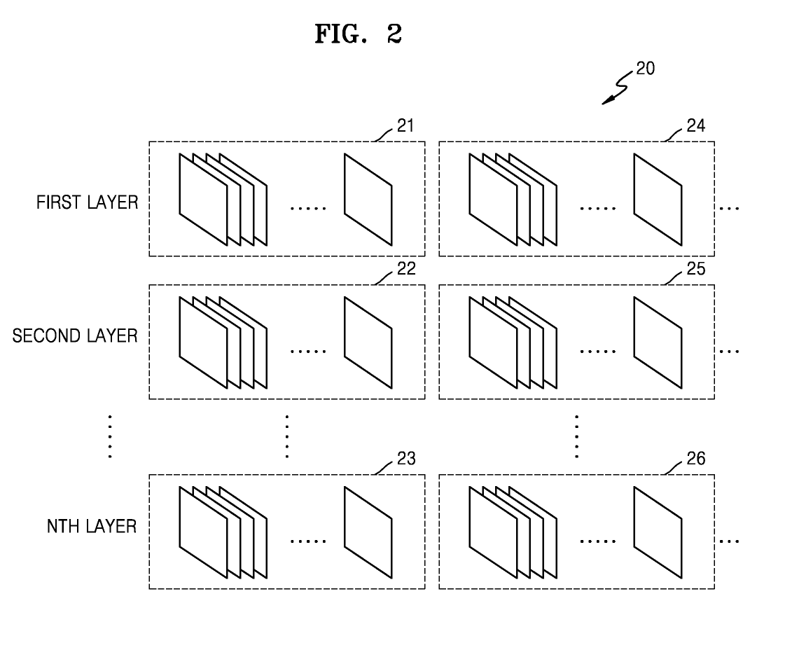

The output unit 12 corresponds to a network abstraction layer (NAL) that adds and outputs encoded multilayer video data and additional information to a transmission data unit of a predetermined format. The transmission data unit may be an NAL unit. The output unit 12 adds prediction encoding data of the multilayer video output from the video encoder 11 and additional information related to prediction encoding to the NAL unit and outputs the NAL unit. In particular, the output unit 12 according to an embodiment adds the reference layer information of each layer to a video parameter set (VPS) NAL unit including information commonly applied to image sequences included in the multilayer video, and, when a reference layer referred to by an image sequence of each layer is changed at a predetermined point, adds change information of the reference layer to a supplemental enhancement information (SEI) message NAL unit. FIG. 2 illustrates multilayer video according to an embodiment of the present invention.

To allow various terminals to provide an optimal service in various network environments, the multilayer video encoding apparatus 10 may output a scalable bitstream including various spatial resolutions, various qualities, and various frame rates. The multilayer video encoding apparatus 10 may also encode multi-view image sequences having different views and output a bitstream with respect to an image sequence of each view.

Referring to FIG. 2, first layer image sequences 21 and 24, second layer image sequences 22 and 25, and nth (where n is an integer) layer image sequences 23 and 26 correspond to image sequences of a predetermined view among multi-view image sequences or image sequences of a predetermined layer among a scalable image. For example, the first layer image sequences 21 and 24 may be first view image sequences, the second layer image sequences 22 and 25 may be second view image sequences, and the nth hierarchy image sequences 23 and 26 may be nth view image sequences.

As another example, the first layer image sequences 21 and 24 may be base layer image sequences, and the second layer image sequences 22 and 25 and the nth hierarchy image sequences 23 and 26 may be enhancement layer image sequences.

Image sequences may be separated as coded video sequences (CVS). CVSs is are pictures sharing VPS information and indicate image sequences decoded between

VPS NAL units. For example, the first layer first image sequence 21 and second image sequence 24 are CVSs and may use different VPS information in FIG. 2. The first layer first image sequence 21, the second layer first image sequence 22, and the nth layer first image sequence 23 may share same VPS information in FIG. 2. The first layer second image sequence 24, the second layer second image sequence 25, and the nth layer second image sequence 26 may share same VPS information in FIG. 2.

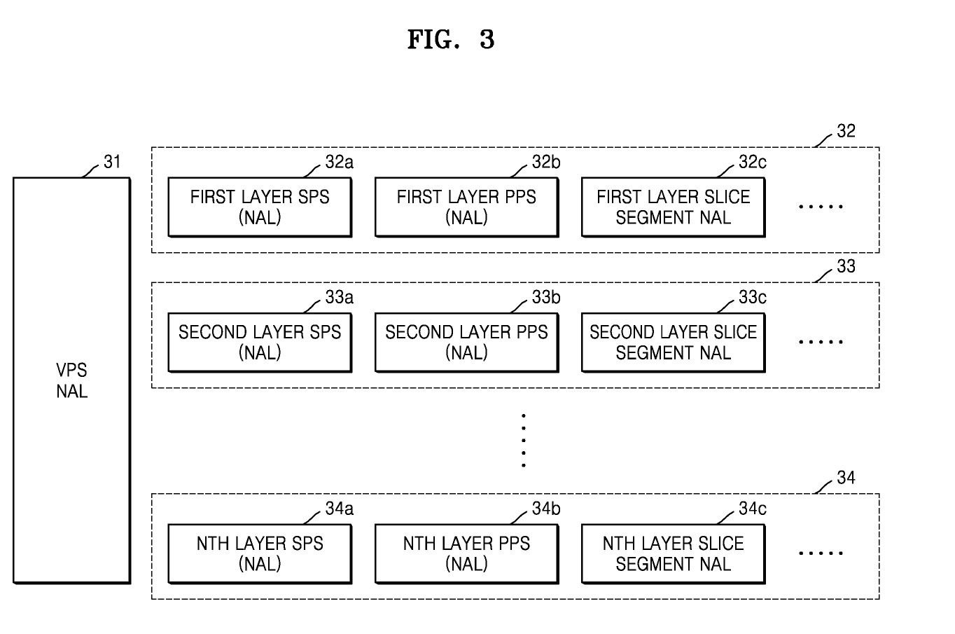

FIG. 3 illustrates NAL units including encoded data of multilayer video according to an embodiment of the present invention.

As described above, the output unit 12 outputs the NAL units including the encoded data of the multilayer video and additional information. A VPS NAL unit 31 includes information applied to multilayer image sequences 32, 33, and 34 included in the multilayer video. The VPS NAL unit 31 includes a common syntax element shared by the multilayer image sequences 32, 33, and 34, information regarding an operation point to block transmission of unnecessary information, indispensable information regarding an operation point necessary for a session negotiation like a profile or a level, and the like. In particular, the output unit 12 according to an embodiment may include information regarding a reference layer referred to by pictures included in an image sequence of each layer of a multilayer in the VPS NAL unit 31. The reference layer information included in the VPS NAL unit 31 will be described later.

The output unit 12 may generate and output sequence parameter set (SPS) NAL units 32a, 33a, and 34a, picture parameter set (PPS) NAL units 32b, 33b, and 34b, and slice segment NAL units 32c, 33c, 34c.

An SPS NAL unit includes information commonly applied to an image sequence of one layer. For example, the SPS NAL units 32a, 33a, and 34a respectively include information commonly applied to the image sequences 32, 33, and 34. A PPS NAL unit includes information commonly applied to pictures of one layer. For example, each of the PPS NAL units 32b, 33b, and 34b includes information commonly applied to the pictures of one layer. The PPS NAL unit may include information regarding an encoding mode of an entire picture, for example, an entropy encoding mode, a quantization parameter initialization value of a picture unit, and the like. The PPS NAL unit may not be necessarily generated for every picture. That is, an decoding side uses a previously received PPS NAL unit when there is no PPS NAL unit. The output unit 12 may generate and output a new PPS NAL unit when the information included in the PPS is NAL unit needs to be renewed. A slice segment NAL unit includes information commonly applied to one slice. A slice segment includes encoding data of at least one maximum coding unit and may be transmitted by being included in the slice segment NAL units 32c, 33c, 34c.

The output unit 12 may generate and output a supplemental enhancement information (SEI) message NAL unit. The SEI message indicates additional information necessary for a decoding process in a video encoding layer (VCL). For example, a SEI message may include timing information of each picture related to a hypothetical reference decoder (HRD), information regarding a pan/scan function, and the like. In particular, the output unit 12 according to an exemplary embodiment adds and outputs change information of a reference layer referred to by an image sequence of each layer to the SEI message NAL unit when the reference layer is changed at a predetermined point unlike reference layer information defined in a VPS. The reference layer change information included in the SEI message will be described later.

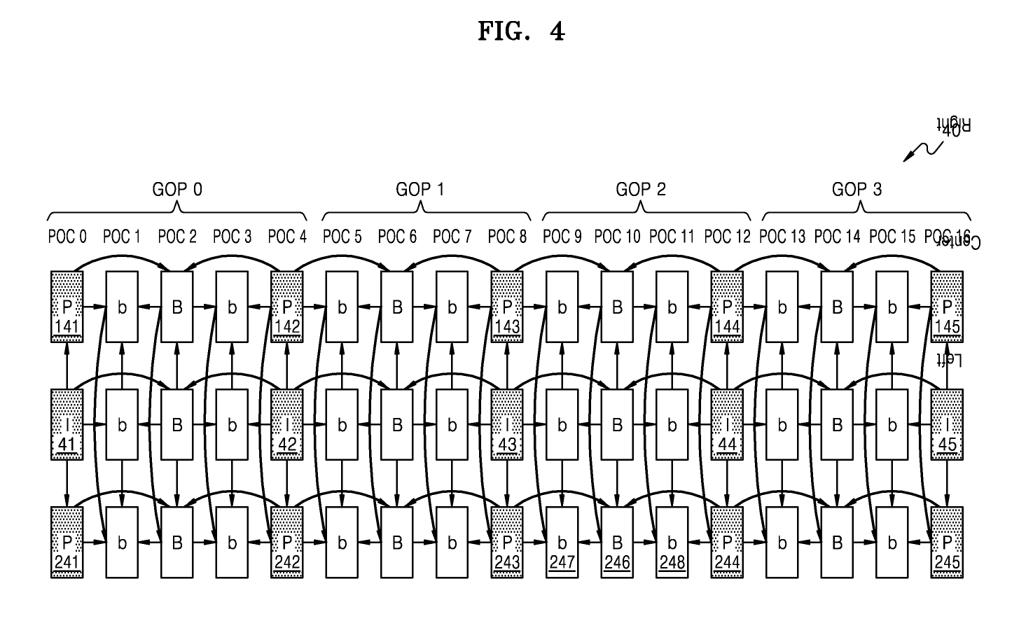

FIG. 4 illustrates an example of an inter layer prediction structure 40 according to an embodiment of the present invention.

As described above, the video encoding apparatus 10 according to an exemplary embodiment may perform inter layer prediction referring to pictures of another layer when pictures included in an image sequence of each layer is prediction encoded. For example, the inter layer prediction structure 40 of FIG. 4 is a prediction structure for prediction encoding of stereoscopic image sequences configured as a center view image, a left view image, and a right view image. In FIG. 4, an arrow indicates a reference direction of each picture. An image from which the arrow starts is a reference picture, and an image to which the arrow is directed is a picture referenced by using the reference picture. For example, a center view I picture 41 is used as a reference picture of a left view P picture 141 and a right view P picture 241. Pictures having a same picture order count (POC) order are arranged in a vertical direction. In the inter layer prediction structure 40, “POC #” indicates a relative reproduction order of pictures positioned in a corresponding column. Four consecutive images of view images constitute a single group of pictures (GOP). Each GOP includes images between consecutive anchor pictures and a single key picture.

The anchor picture is a random access point, and in this regard, when a predetermined reproduction position is selected from images that are arranged according to a reproduction order of video, that is, according to a POC, an anchor picture is of which a POC is closest to the reproduction position is reproduced. The base view images include base view anchor pictures 41, 42, 43, 44, and 45, the left view images include left view anchor pictures 141, 142, 143, 144, and 145, and the right view images include right view anchor pictures 241, 242, 243, 244, and 245. According to the inter layer prediction structure 40, inter layer prediction referring to not only a same layer image but also another layer image may be performed.

As described above, when inter layer prediction is allowed when multilayer video is encoded, reference layer information regarding which layer is referred to by a picture that is prediction encoded through inter layer prediction needs to be transmitted for decoding.

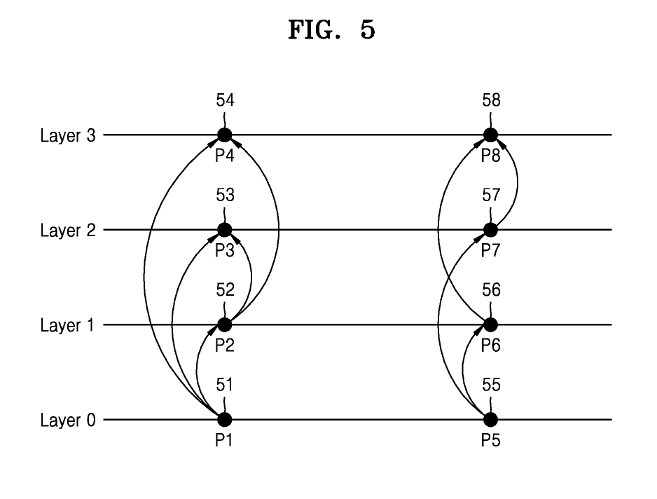

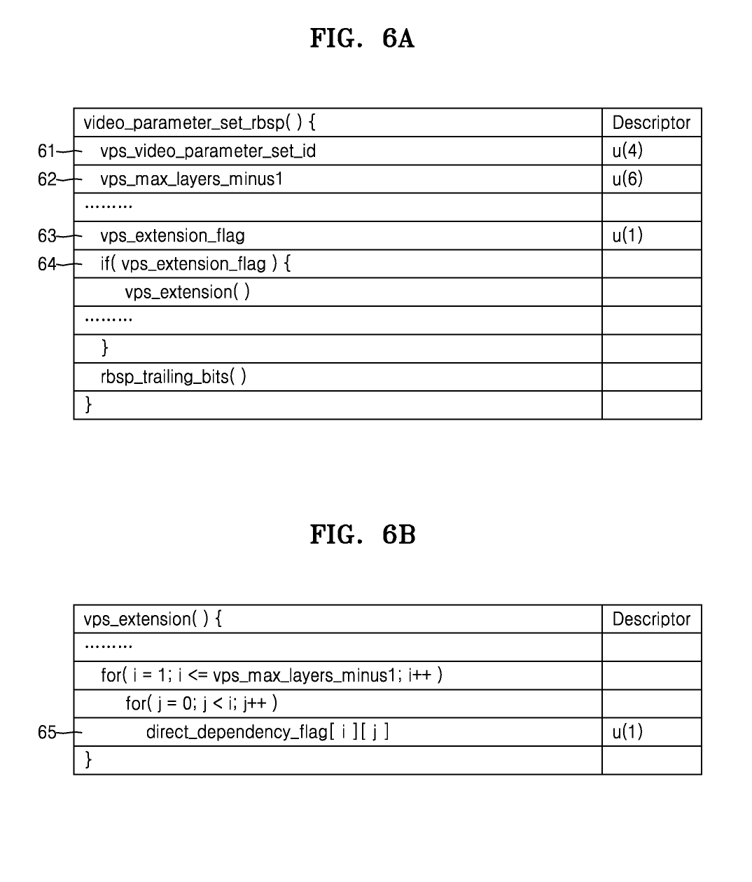

A method of transmitting the reference layer information during inter layer prediction according to an exemplary embodiment will be described in detail with reference to FIGS. 5 through 6B below.

FIG. 5 illustrates an example of an inter layer prediction structure in multilayer video. As described with reference to FIG. 4 above, an arrow of FIG. 5 indicates a reference direction. In layer #, # is a layer index. A layer having an # index may be referred to as an (#+1)th layer.

Referring to FIG. 5, it is assumed that a second layer (layer 1) P2 picture 52 is predicted by referring to a first layer (layer 0) P1 picture 51, a third layer (layer 2) P3 picture 53 is predicted by referring to the first layer (layer 0) P1 picture 51 and the second layer (layer 1) P2 picture 52, and a fourth layer (layer 3) P4 picture 54 is predicted by referring to the first layer (layer 0) P1 picture 51 and the second layer (layer 1) P2 picture 52. It is assumed that a second layer (layer 1) P6 picture 56 is predicted by referring to a first layer (layer 0) P5 picture 55, a third layer (layer 2) P7 picture 57 is predicted by referring to the first layer (layer 0) P5 picture 55, and a fourth layer (layer 3) P8 picture 58 is predicted by referring to the second layer (layer 1) P6 picture 56 and the third layer (layer 2) P7 picture 57.

When the output unit 12 has the inter layer prediction structure as shown in FIG. 5, the output unit 12 may include information regarding a reference layer referred to by pictures included in an image sequence of each layer of a multilayer in a VPS NAL unit.

An inter layer prediction relationship is changed after the P1 picture 51 through P4 picture 54, and thus an inter layer prediction relationship between the P1 picture 51 through P4 picture 54 and an inter layer prediction relationship between the P5 picture 55 through P8 picture 58 are not the same. When the inter layer prediction relationship is is changed at a predetermined point of the image sequence as described above, the output unit 12 may include change information of a changed reference layer in an SEI message NAL unit.

FIG. 6A illustrates a VPS NAL unit according to an embodiment of the present invention. FIG. 6B illustrates extension VPS information included in the VPS NAL unit according to an embodiment of the present invention.

Referring to FIG. 6A, a raw byte sequence payload (RBSP) of the VPS NAL unit includes vps_video_parameter_set_id 61, vps_max_layers_minusl 62, vps_extension_flag 63, and vps_extension 64 syntax. The vps_video_parameter_set_id 61 is used to identify a VPS referred to by another syntax. A separate VPS NAL unit may be transmitted for each CVS, and thus the vps_video_parameter_set_id 61 is used to identify the VPS that is to be applied to a current image sequence among a plurality of VPS NAL units for decoding of an image sequence. The vps_max_layers_minusl 62 indicates the number of layers included in a multilayer. For example, with respect to multilayer video configured as four layers as shown in FIG. 5, the vps_max_layers_minusl 62 has a value of (the number of all layers −1). The vps_extension_flag 63 indicates whether to use a separate VPS extension information. When the vps_extension_flag 63 is 0, no separate VPS extension information is included in the VPS. When the vps_extension_flag 63 is 1, the VPS extension information is included in the VPS. The vps_extension_flag 63 is used for a compatibility with a conventional codec using the VPS.

The vps_extension 64 is syntax added to transmit separate additional information while being compatible with a conventional codec using a VPS, and includes direct_dependency_flag[i][j] 65. i and j (i and j are integers) are indexes of each layer to have values in the range from 0 to the vps_max_layers_minusl 62.

The direct_dependency_flag[i][j] 65 corresponds to information regarding a reference layer referred to by pictures included in an image sequence of each layer of a multilayer, and is a flag indicating whether a picture that uses a picture of a jth (where j is an integer) layer as a reference picture exists among pictures of an ith (where i is an integer) layer. When the direct_dependency_flag[i][j] 65 is 0, the direct_dependency_flag[i][j] 65 indicates that the picture that uses the picture of the jth layer as the reference picture does not exist among the pictures of the ith layer. When the direct_dependency_flag[i][j] 65 is 1, the direct_dependency_flag[i][j] 65 indicates that the picture that uses the picture of the jth layer as the reference picture exists among the is pictures of the ith layer. The direct_dependency_flag[i][j] 65 indicates the reference layer information in inter layer prediction, and thus the direct_dependency_flag[i][j] 65 is not defined when i and j are the same.

Referring to FIG. 5, a layer index of a first layer (layer 0) is 0, a layer index of a second layer (layer 1) is 1, a layer index of a third layer (layer 2) is 2, and a layer index of a fourth layer (layer 3) is 3. Based on the inter layer prediction relationship between the P1 picture 51 through P4 picture 54 and the inter layer prediction relationship between the P5 picture 55 through P8 picture 58 of FIG. 5, the output unit 12 may set the direct_dependency_flag[i][j] 65 as follows.

{
direct_dependency_flag[1][0]=1;
direct_dependency_flag[2][0]=1;
direct_dependency_flag[2][1]=1;
direct_dependency_flag[3][0]=1;
direct_dependency_flag[3][1]=1;
direct_dependency_flag[3][2]=1;
}

As described above, the direct_dependency_flag[i][j] 65 merely indicates whether the picture that uses the picture of the jth layer as the reference picture exists among pictures of the ith layer and does not indicate an inter layer prediction relationship of one picture of a specific layer. When an inter layer reference relationship of an image sequence is changed, such a change is not indicated by the direct_dependency_flag[i][j] 65.

For example, the third layer (layer) 2 P7 picture 57 refers to a different layer from the third layer (layer 2) P3 picture 53. The fourth layer (layer 3) P8 picture 58 refers to a different layer from the fourth layer (layer 3) P4 picture 54. The P8 picture 58 refers to the second layer (layer 1) P6 picture 56 and the third layer (layer 2) P7 picture 57, and thus the fourth layer (layer 3) P8 picture 58 does not use the first layer (layer 0) referred is to by the same fourth layer (layer 3) P4 picture 54. Thus, a first layer (layer 0) image is not necessary for reproducing the P8 picture 58. However, whether the inter layer prediction relationship is changed may not be determined through the direct_dependency_flag[i][j] 65, and thus the first layer (layer 0) image that is not necessary for reproducing the P8 picture 58 may be decoded.

Therefore, when the inter layer reference relationship is changed at a predetermined point of an image sequence, the output unit 12 according to an exemplary embodiment may include change information of a changed reference layer in a SEI message NAL unit. In more detail, the output unit 12 according to an exemplary embodiment may directly include, in a separate SEI message, a reference layer index referred to by pictures included in the image sequence after the predetermined point at which the inter layer prediction relationship is changed for each layer. The output unit 12 according to another exemplary embodiment may include, in the SEI message, flag information indicating whether the inter layer prediction relation defined by the direct_dependency_flag[i][j] 65 is maintained with respect to the pictures included in the image sequence after the predetermined point.

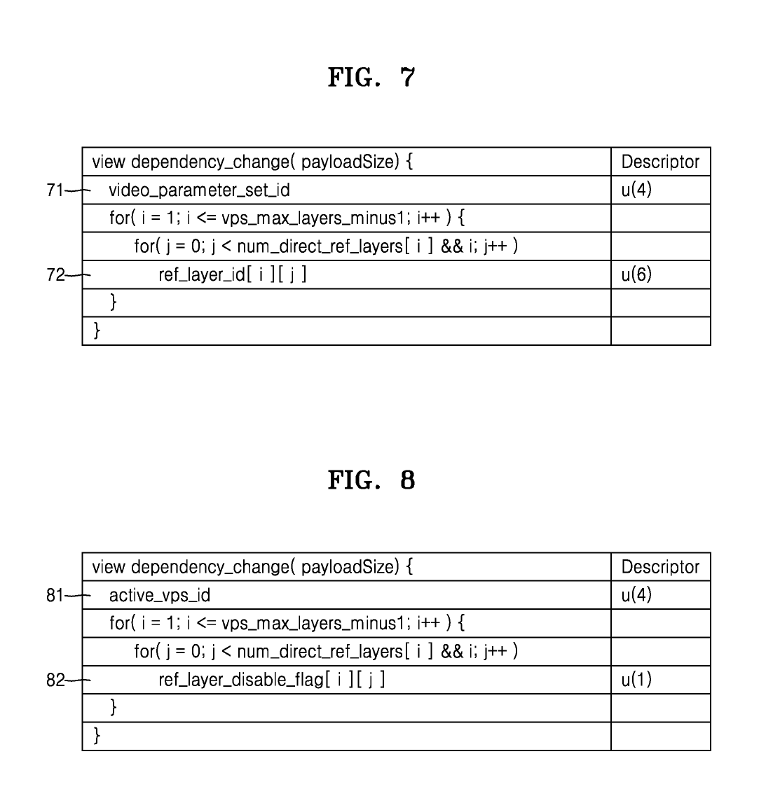

FIG. 7 illustrates a SEI message NAL unit according to an embodiment of the present invention.

Referring to FIG. 7, the output unit 12 according to an exemplary embodiment may include, in the SEI message NAL unit, ref_layer_id[i][j] 72 syntax indicating a reference layer index referred to by pictures included in an image sequence after a predetermined point in order to indicate whether an inter layer prediction relationship is changed. In FIG. 7, vps_parameter_set_id 71 is an identifier for identifying a VPS NAL unit including direct_dependency_flag[i][j] regarding the inter layer prediction relationship, and num_direct_ref_layer[i] indicates the number of all layers referred to by an (i+1)th layer having an index i of multilayer video. For example, layers referred to by the P3 picture 53 and the P7 picture 57 that are third layer (layer 2) pictures in FIG. 5 are the first layer (layer 0) and the second layer (layer 1), and thus num_direct_ref_layer[2]=2. As another example, layers referred to by the P4 picture 54 and the P8 picture 58 that are fourth layer (layer 3) pictures are the first layer (layer 0), the second layer (layer 1), and the third layer (layer 2), and thus num_direct_ref_layer[3]=3.

The ref_layer_id[i][j] 72 directly indicates an index of a layer referred to by pictures of a layer having the index i. The ref_layer_id[i][j] 72 indicates a specific index number is of a (j+1)th referred layer by the pictures of the layer having the index i. For example, the number of layers referred to by the third layer (layer 2(P3 picture 53 and the third layer (layer 2) P7 picture 57 in FIG. 5 is 2 including the first layer (layer 0) and the second layer (layer 1). However, the P7 picture 57 refers to only the first layer (layer 0), and thus the output unit 12 sets and adds a value of 0 as ref_layer_id[2][0] syntax indicating an index of a first layer referred to by the third layer (layer 2) P7 picture 57 to a SEI message but does not add ref_layer_id[2][1]. When ref_layer_id[2][0] having the value of 0 is included in the SEI message NAL unit, a decoding side may determine that a layer referred to by a third layer picture decoded after the SEI message NAL unit is the first layer (layer 0). When ref_layer_id[2][1] is not included in the SEI message NAL unit, the decoding side may determine that the layer referred to by the third layer picture is the first layer (layer 0).

As long as ref_layer_id[i][j] is not transmitted through another SEI message, ref_layer_id[i][j] transmitted through the SEI message is applied to a final picture of a CVS picture from pictures encoded (or decoded) after the SEI message NAL unit. When it is necessary to define the inter layer prediction relationship in a same CVS, the output unit 12 adds and transmits ref_layer_id[i][j] to another SEI message NAL unit.

FIG. 8 illustrates a SEI message NAL unit according to another embodiment of the present invention.

Referring to FIG. 8, the output unit 12 according to another exemplary embodiment may include, in the SEI message NAL unit, ref_layer_disable_flag[i][j] 82 that is a flag indicating whether an inter layer prediction relationship defined by direct_dependency_flag[i][j] included in a VPS NAL unit is maintained with respect to pictures included in an image sequence after a predetermined point.

In FIG. 8, active_vps_id 81 is an identifier for identifying a VPS NAL unit including direct_dependency_flag[i][j] regarding an inter layer prediction relationship, and the ref_layer_disable_flag[i][j] 82 indicates whether a layer of an index j determined to be used as a reference picture of pictures of a layer having an index i by direct_dependency_flag[i][j] is continuously used as the reference picture of the pictures of the layer having the index i. When the ref_layer_disable_flag[i][j] 82 is 0, the ref_layer_disable_flag[i][j] 82 indicates that the layer of the index j is not any longer used as the reference picture of the pictures of the layer having the index i. When the ref_layer_disable_flag[i][j] 82 is 1, the ref_layer_disable_flag[i][j] 82 indicates that the layer of the index j is continuously used as the reference picture of the pictures of the is layer having the index i. As described in an example above, the third layer (layer 2) P7 picture 57 does not refer to the second layer (layer 1) among the first layer (layer 0) and the second layer (layer 1) that are referred to by the third layer (layer 2) P3 picture 53 in FIG. 5. Thus, the output unit 12 sets and adds a value of 0 as ref_layer_disable_flag [2][0] indicating whether the third layer (layer 2) P7 picture 57 continuously refers to the first layer (layer 0) referred to by the third layer (layer 2) P3 picture 53 to a SEI message, and sets and adds a value of 1 as ref_layer_disable_flag [2][1] indicating whether the third layer (layer 2) P7 picture 57 continuously refers to the second layer (layer 1) referred to by the third layer (layer 2) P3 picture 53 to the SEI message. When ref_layer_disable_flag [2][0] having the value of 0 is included in the SEI message NAL unit, a decoding side may determine that a first layer is no longer referred to among layers used as a reference picture of the third layer (layer 2) by ref_layer_disable_flag [2][j] included in the VPS NAL unit. When ref_layer_disable_flag [2][1] having the value of 1 is included in the SEI message NAL unit, the decoding side may determine that a second layer is continuously used as a reference picture for inter layer prediction among the layers used as the reference picture of the third layer (layer 2) by ref_layer_disable_flag [2][j] included in the VPS NAL unit.

As long as ref_layer_disable_flag[i][j] is not transmitted through another SEI message, ref_layer_disable_flag[i][j] 82 transmitted through the SEI message is applied to a final picture of a CVS picture from pictures encoded (or decoded) after the SEI message NAL unit. When it is necessary to define another inter layer prediction relationship in a same CVS, the output unit 12 adds and transmits ref_layer_disable_flag[i][j] 82 to another SEI message NAL unit.

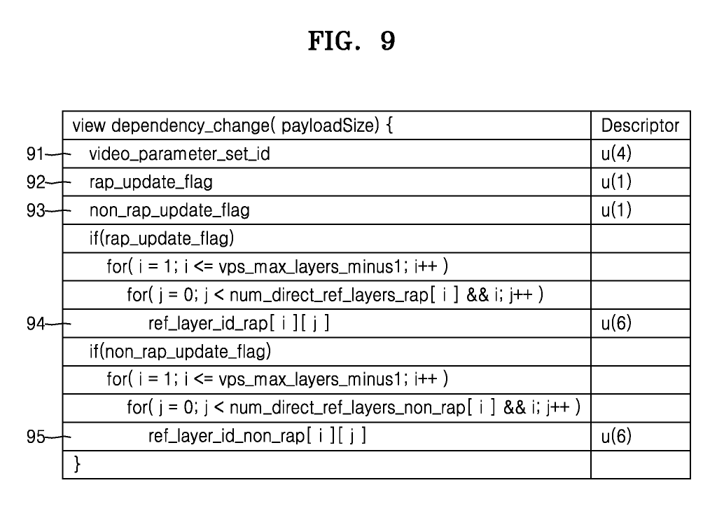

FIG. 9 illustrates a SEI message NAL unit according to another embodiment of the present invention.

The output unit 12 may add pictures included in an image sequence of each layer as a random access point (referred to as a RAP) picture and a non-random access point (referred to as a non-RAP) picture, and when a reference layer referred to by the RAP picture is changed, may add change information of a reference layer referred to by the RAP picture to the SEI message NAL unit, and, when a reference layer referred to by the non-RAP picture is changed, may add change information of a reference layer referred to by the non-RAP picture to the SEI message NAL unit.

I type RAP pictures may be one of instantaneous decoding refresh (IDR) pictures, clean random access (CRA) pictures, broken link access (BLA) pictures, a temporal is sublayer access (TSA) pictures, and stepwise temporal sublayer access (STSA) pictures. Leading pictures may be classified as random access decodable leading (RADL) pictures and random access skipped leading (RASL) pictures. Pictures other than the RAP picture are referred to as non-RAP pictures.

Referring to FIG. 9, vps_parameter_set_id 91 is an identifier for identifying a VPS NAL unit including direct_dependency_flag[i][j] regarding an inter layer prediction relationship, and rap_update_flag 92 indicates whether reference layer change information regarding RAP pictures is included in an SEI message. non_rap_update_flag 93indicates whether reference layer change information regarding non-RAP pictures is included in the SEI message.

Similarly to the ref_layer_id[i][j] 72 of FIG. 7 described above, ref_layer_id_rap[i][j] 94 directly indicates an index of a layer referred to by the RAP pictures of a layer having an index i. The ref_layer_id_rap[i][j] 94 indicates a specific index number of a (j+1)th referenced layer by the RAP pictures of the layer having the index i.

Similarly, ref_layer_id_non_rap[i][j] 95 directly indicates an index of a layer referred to by the non-RAP pictures of the layer having the index i. The ref_layer_id_non_rap[i][j] 95 indicates a specific index number of a (j+1)th referenced layer by the non-RAP pictures of the layer having the index i.

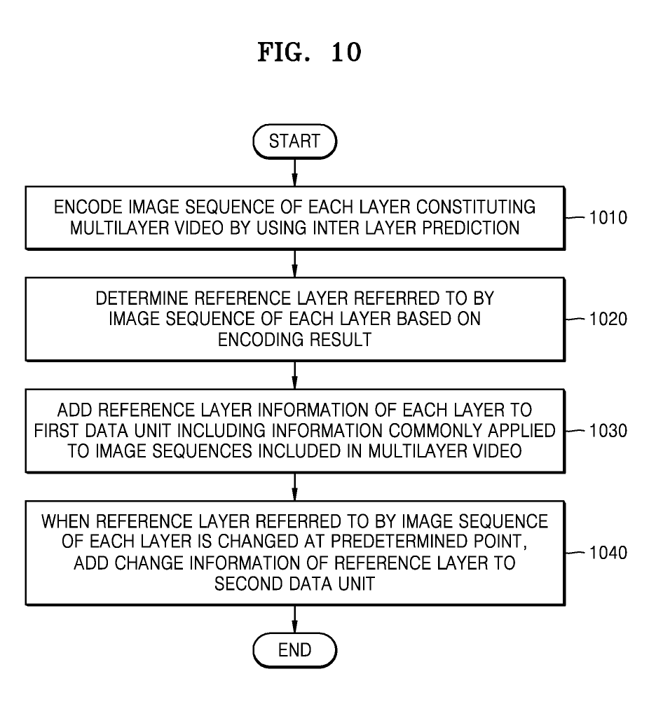

FIG. 10 is a flowchart of a multilayer encoding method according to an embodiment of the present invention.

Referring to FIGS. 1 and 10, in operation 1010, the video encoder 11 encodes an image sequence of each layer constituting multilayer video by using inter layer prediction. The video encoder 11 encodes the multilayer video based on a coding unit of a tree structure, a prediction unit, and a transformation unit, performs inter layer prediction by using a correlation between layers, in particular, during prediction, and determines a reference relationship between layers.

In operation 1020, the output unit 12 determines a reference layer referred to by the image sequence of each layer based on an encoding result, and in operation 1030, the output unit 12 adds reference layer information of each layer to a first data unit, i.e. a VPS NAL unit, including information commonly applied to image sequences included in the multilayer video.

In operation 1040, when the reference layer referred to by the image sequence of each layer is changed at a predetermined point, the output unit 12 adds change information of the reference layer to a second data unit, i.e. a SEI message NAL unit. is As described above, the output unit 12 according to an exemplary embodiment may add ref_layer_id indicating a reference layer index referred to by pictures included in the image sequence after the predetermined point in which an inter layer prediction relationship is changed for each layer, to the SEI message NAL unit. The output unit 12 according to another exemplary embodiment may include, in a SEI message, ref_layer_disable_flag that is flag information indicating whether an inter layer prediction relationship defined by direct_dependency_flag[i][j] is maintained with respect to pictures included in the image sequence after the predetermined point.

The output unit 12 according to another exemplary embodiment may classify pictures included in the image sequence of each layer into a RAP picture and a non-RAP picture, when a reference layer referred to by the RAP picture is changed, may add ref_layer_id_rap that is change information of a reference layer referred to by the RAP picture to the SEI message NAL unit, and, when a reference layer referred to by the non-RAP picture is changed, may add ref_layer_id_non_rap that is change information of a reference layer referred to by the non-RAP picture to the SEI message NAL unit.

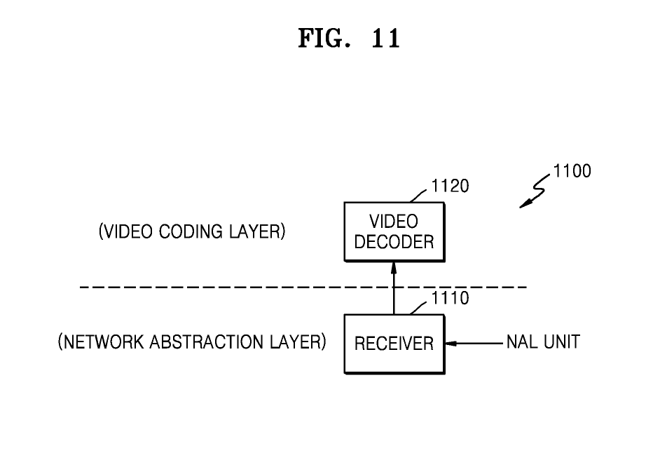

FIG. 11 is a block diagram of a multilayer video decoding apparatus 1100 according to an embodiment of the present invention.

Referring to FIG. 11, the multilayer video decoding apparatus 1100 according to an exemplary embodiment includes a receiver 1110 and a video decoder 1120.

The receiver 1110 may receive a NAL unit to identify which information is included in the NAL unit among a VPS, an SPS, a PPS, a slice segment, and SEI messages by using type information on nal unit type included in a NAL unit header.

The receiver 1110 obtains reference layer information of each layer constituting a multilayer from a VPS NAL unit. As described with reference to FIG. 6B above, the receiver 1110 parses and obtains direct_dependency_flag[i][j] from the VPS NAL unit. The video decoder 1120 may determine whether a picture that uses a picture of a jth (where j is an integer) layer as a reference picture exists among pictures of an ith (where i is an integer) layer based on direct_dependency_flag[i][j] to determine a reference relationship of each layer.

The receiver 1110 obtains change information of a reference layer referred to by an image sequence of each layer from a SEI message NAL unit. As described with reference to FIGS. 7 and 8 above, the receiver 1110 parses and obtains ref_layer[i][j] or ref_layer_disable_flag[i][j] from a SEI message unit. The video decoder 1120 may change a reference layer referred to by an image sequence of each layer decoded after is the received SEI message NAL unit based on the change information of the reference layer.

The receiver 1110 may parse and obtain ref_layer_id_rap that is change information of a reference layer referred to by a RAP picture from a SEI message. The video decoder 1120 may change the reference layer referred to by the RAP picture based on ref_layer_id_rap. The receiver 1110 may parse and obtain ref_layer_id_non_rap that is change information of a reference layer referred to by a non-RAP picture from the SEI message NAL unit. The video decoder 1120 may change the reference layer referred to by the non-RAP picture based on ref_I aye r_i d_no n_rap.

The video decoder 1120 determines a reference relationship between layers based on an inter layer prediction relationship included in the VPS NAL unit and the SEI message NAL unit and decodes each picture according to a prediction mode of each picture. The video decoder 1120 may decode multilayer video based on coding units of a tree structure.

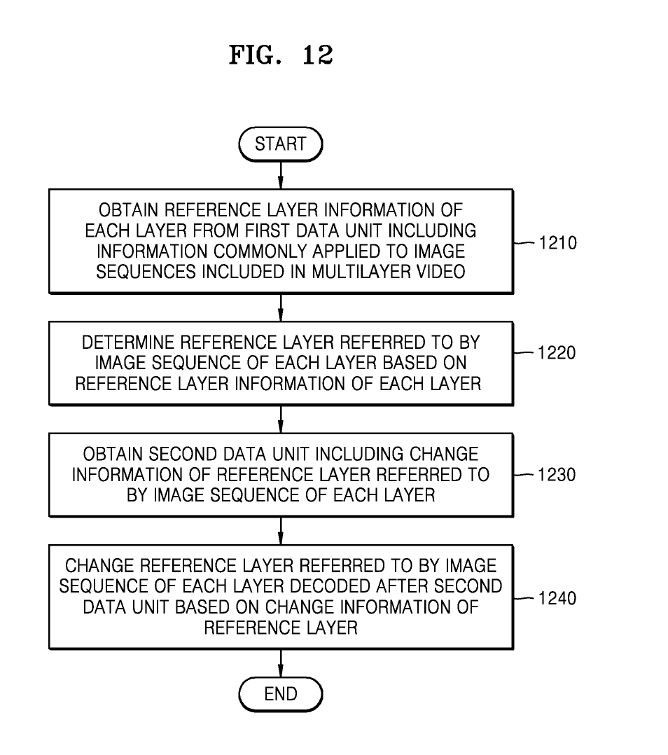

FIG. 12 is a flowchart of a multilayer decoding method according to an embodiment of the present invention.

Referring to FIGS. 11 and 12, in operation 1210, the receiver 1110 obtains reference layer information of each layer from a first data unit, i.e., a VPS NAL unit, including information commonly applied to image sequences included in multilayer video. As described with reference to FIGS. 7 and 8 above, the receiver 1110 parses and obtains ref_layer[i][j] or ref_layer_disable_flag[i][j] from a SEI message unit.

In operation 1220, the video decoder 1120 determines a reference layer referred to by an image sequence of each layer based on ref_layer_disable_flag[i][j] that is reference layer information of each layer obtained from the VPS NAL unit.

In operation 1230, the receiver 1110 obtains a second data unit, i.e., a SEI message NAL unit, including change information of the reference layer referred to by the image sequence of each layer. As described with reference to FIGS. 7 and 8 above, the receiver 1110 parses and obtains ref_layer[i][j] or ref_layer_disable_flag[i][j] from the SEI message unit. The video decoder 1120 may change a reference layer referred to by an image sequence of each layer decoded after the received SEI message NAL unit based on the change information of the reference layer.

In operation 1240, the video decoder 1120 may change the reference layer referred to by the image sequence of each layer decoded after the received SEI is message NAL unit.

A video encoding method and apparatus and a video decoding method and apparatus based on coding units having a tree structure, according to exemplary embodiments of the present invention, will be described with reference to FIGS. 13 through 25. The video encoding method and apparatus and the video decoding method and apparatus based on coding units having the tree structure that will be described below are related to processes of encoding/decoding pictures included in multilayer video performed by the video encoder 11 of the video encoding apparatus 10 of FIG. 1 and the video decoder 1120 of the video decoding apparatus 1100 of FIG. 11.

FIG. 13 is a block diagram of a video encoding apparatus 100 based on coding units having a tree structure, according to an embodiment of the present invention.

The video encoding apparatus 100 accompanied by a video prediction based on the coding units having the tree structure according to an embodiment includes a maximum coding unit splitter 110, a coding unit determiner 120, and an output unit 130. Hereinafter, for convenience of description, the video encoding apparatus 100 accompanied by the video prediction based on the coding units having the tree structure, according to an embodiment, is referred to as a “video encoding apparatus 100”.

The maximum coding unit splitter 110 may split a current picture based on a maximum coding unit that is a coding unit having a maximum size for the current picture of an image. If the current picture is larger than the maximum coding unit, image data of the current picture may be split into the at least one maximum coding unit. The maximum coding unit according to an embodiment may be a data unit having a size of 32×32, 64×64, 128×128, or 256×256, wherein a shape of the data unit is a square having a width and length in squares of 2. The image data may be output to the coding unit determiner 120 according to the at least one maximum coding unit.

A coding unit according to an embodiment may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an embodiment is split according to depths, the image data of a spatial domain included in the maximum coding unit may be hierarchically classified according to depths.

A maximum depth and a maximum size of a coding unit, which limit a total number of times a height and a width of the maximum coding unit are hierarchically split may be previously set.

The coding unit determiner 120 encodes at least one split region obtained by splitting a region of the maximum coding unit according to depths, and determines a depth to output final encoding results according to the at least one split region. In other words, the coding unit determiner 120 determines a coded depth by encoding the image data in the deeper coding units according to depths, according to the maximum coding unit of the current picture, and selecting a depth having a least encoding error. The determined coded depth and the image data according to the maximum coding unit are output.

The image data in the maximum coding unit is encoded based on the deeper coding units corresponding to at least one depth equal to or less than the maximum depth, and encoding results are compared based on each of the deeper coding units. A depth having the least encoding error may be selected after comparing encoding errors of the deeper coding units. At least one coded depth may be selected for each maximum coding unit.

A size of the maximum coding unit is split as a coding unit is hierarchically split according to depths, and a number of coding units increases. Also, even if coding units correspond to the same depth in one maximum coding unit, it is determined whether to split each of the coding units corresponding to the same depth to a lower depth by measuring an encoding error of the data of each coding unit, separately. Accordingly, even when data is included in one maximum coding unit, the encoding errors according to depths may differ according to regions, and thus the coded depths may differ according to regions. Thus, one or more coded depths may be set for one maximum coding unit, and the data of the maximum coding unit may be divided according to coding units of the one or more coded depths.

Accordingly, the coding unit determiner 120 according to an embodiment may determine coding units having a tree structure included in a current maximum coding unit. The ‘coding units having a tree structure’ according to an embodiment of the present invention include coding units corresponding to a depth determined to be a coded depth, from among all coding units corresponding to depths included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an embodiment is an index related to a number of times splitting is performed from a maximum coding unit to a minimum coding unit. A first maximum depth according to an embodiment may denote a total number of times splitting is performed from the maximum coding unit to the minimum coding unit. A second maximum depth according to an embodiment may denote a total number of depth levels from the maximum coding unit to the minimum coding unit. For example, when a depth of the maximum coding unit is 0, a depth of a coding unit in which the maximum coding unit is split once may be set to 1, and a depth of a coding unit in which the maximum coding unit is split twice may be set to 2. In this case, if the minimum coding unit is a coding unit obtained by splitting the maximum coding unit four times, 5 depth levels of depths 0, 1, 2, 3 and 4 exist, and thus the first maximum depth may be set to 4 and the second maximum depth may be set to 5.

Prediction encoding and frequency transformation may be performed according to the maximum coding unit. The prediction encoding and the transformation are also performed based on the deeper coding units according to a depth equal to or depths less than the maximum depth, according to the maximum coding unit.

Since a number of deeper coding units increases whenever the maximum coding unit is split according to depths, encoding including the prediction encoding and the frequency transformation has to be performed on all of the deeper coding units generated as the depth increases. For convenience of description, the prediction encoding and the frequency transformation will now be described based on a coding unit of a current depth, from among at least one maximum coding unit.

The video encoding apparatus 100 according to an embodiment may variously select a size or shape of a data unit for encoding the image data. In order to encode the image data, operations, such as prediction encoding, frequency transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit.

For example, when a coding unit of 2N×2N (where N is a positive integer) is no longer split, the coding unit may become a prediction unit of 2N×2N and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to an embodiment may also perform the transformation on the image data in a coding unit based not only on the coding unit for encoding the image data but also based on a data unit that is different from the coding unit. In order to perform the transformation in the coding unit, the transformation may be performed based on a transformation unit having a size smaller than or equal to the coding unit. For example, the transformation unit may include a transformation unit for an intra mode and a data unit for an inter mode.

Similarly to the coding unit in a tree structure according to an embodiment, the transformation unit in the coding unit may be recursively split into smaller sized transformation units, and thus, residual data in the coding unit may be divided according to the transformation unit having a tree structure according to transformation depths.

A transformation depth indicating a number of times splitting is performed to reach the transformation unit by splitting the height and width of the coding unit may also be set in the transformation unit according to an embodiment. For example, in a current coding unit of 2N×2N, a transformation depth may be 0 when the size of a transformation unit is 2N×2N, may be 1 when the size of a transformation unit is N×N, and may be 2 when the size of a transformation unit is N/2×N/2. That is, the transformation unit having the tree structure may also be set according to transformation depths.

Encoding information according to coding units corresponding to a coded depth requires not only information about the coded depth but also about information related to prediction and transformation. Accordingly, the coding unit determiner 120 not only determines a coded depth having a least encoding error but also determines a partition type in a prediction unit, a prediction mode according to prediction units, and a size of a transformation unit for transformation.

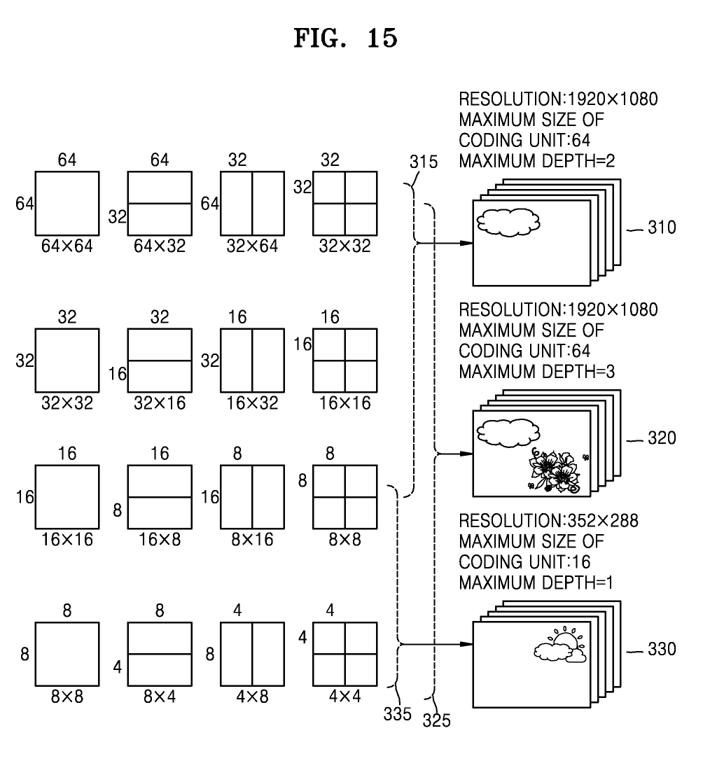

Coding units having a tree structure in a maximum coding unit and a method of determining a prediction unit/partition and a transformation unit according to an embodiment will be described in detail later with reference to FIGS. 15 through 25.

The coding unit determiner 120 may measure an encoding error of deeper coding units according to depths by using Rate-Distortion (RD) Optimization based on Lagrangian multiplier.

The output unit 130 outputs the image data of the maximum coding unit, which is encoded based on the at least one coded depth determined by the coding unit determiner 120, and information about the encoding mode according to the coded depth, in a bitstream.

The encoded image data may be obtained by encoding residual data of an image.

The information about the encoding mode according to coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, the encoding is performed on the current coding unit of the current depth, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit and information about at least one encoding mode is determined for a coding unit of a coded depth, information about at least one encoding mode may be determined for one maximum coding unit. Also, a coded depth of the data of the maximum coding unit may be different according to locations since the data is hierarchically split according to depths, and thus information about the coded depth and the encoding mode may be set for the data.

Accordingly, the output unit 130 according to an embodiment may assign encoding information about a corresponding coded depth and an encoding mode to at least one of the coding unit, the prediction unit, and a minimum unit included in the maximum coding unit.

The minimum unit according to an embodiment is a rectangular data unit obtained by splitting the minimum coding unit constituting a lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to deeper coding units according to depths, and encoding information according to prediction units. The encoding information according to the deeper coding units according to depths may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Also, information about a maximum size of the coding unit defined according to pictures, slices, or GOPs, and information about a maximum depth may be inserted into a header of a bitstream, a sequence parameter set, or a picture parameter set, etc.

Information about a maximum size of the transformation unit allowed for a current video and information about a minimum size of the transformation unit may be output through the header of the bitstream, the sequence parameter set, or the picture parameter set, etc.

In the video encoding apparatus 100 according to a simplest embodiment, the deeper coding unit is a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum number of 4 coding units of the lower depth.

Accordingly, the video encoding apparatus 100 according to an embodiment may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering image characteristics of the coding unit of various image sizes.

Thus, if an image having high resolution or a large data amount is encoded in a conventional macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100 according to an embodiment, image compression efficiency may be increased since a coding unit is adjusted while considering characteristics of an image while increasing a maximum size of a coding unit while considering a size of the image.

FIG. 14 is a block diagram of a video decoding apparatus 200 based on coding units having a tree structure, according to an embodiment of the present invention.

The video decoding apparatus 200 accompanied by a video prediction includes a receiver 210, an image data and encoding information extractor 220, and an image data decoder 230. Hereinafter, for convenience of description, the video decoding apparatus 200 accompanied by the video prediction based on the coding units having the tree structure according to an embodiment is referred to as a “video decoding apparatus 200”.

Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having the tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coded depth, and information about an encoding mode according to each coded depth may include information about a partition type of a corresponding coding unit corresponding to the coded depth, a prediction mode, and a size of a transformation unit. Also, split information according to depths may be extracted as the information about the coded depth.

The information about the coded depth and the encoding mode according to each maximum coding unit extracted by the image data and encoding information extractor 220 is information about a coded depth and an encoding mode determined to generate a least encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to an encoding mode that generates the least encoding error.

Since encoding information about the coded depth and the encoding mode according to an embodiment may be assigned to a predetermined data unit from among a corresponding coding unit, a prediction unit, and a minimum unit, the image data and encoding information extractor 220 may extract the information about the coded depth and the encoding mode according to the predetermined data units. When the information about the coded depth of the corresponding maximum coding unit and the encoding mode is recorded according to the predetermined data units, the predetermined data units having the same information about the coded depth and the encoding mode may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may read transformation unit information according to the tree structure according to coding units and perform inverse transformation based on each transformation unit in the coding unit, so as to perform the inverse transformation according to maximum coding units. A pixel value of the spatial region of the coding unit may be reconstructed.

The image data decoder 230 may determine a coded depth of a current maximum coding unit by using split information according to depths. If the split information indicates that image data is no longer split in the current depth, the current depth is a coded depth. Accordingly, the image data decoder 230 may decode encoded data of the current depth by using the information about the partition type of the prediction unit, the prediction mode, and the size of the transformation unit for image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 according to an embodiment may obtain information about a coding unit that generates the least encoding error when encoding is recursively performed for each maximum coding unit, and may use the information to decode the current picture. In other words, the coding units having the tree structure determined to be the optimum coding units in each maximum coding unit may be decoded.

Accordingly, even if image data has high resolution and a large amount of data, the image data may be efficiently decoded and restored according to a size of a coding unit and an encoding mode, which are adaptively determined according to characteristics of an image, by using information about an optimum encoding mode received from an encoder.

FIG. 15 is a diagram for describing a concept of hierarchical coding units according to an embodiment of the present invention.

A size of a coding unit may be expressed in width x height, and examples of the size of the coding unit may include 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is set to 1920×1080, a maximum size of a coding unit is set to 64, and a maximum depth is set to 2. In video data 320, a resolution is set to 1920×1080, a maximum size of a coding unit is set to 64, and a maximum depth is set to 3. In video data 330, a resolution is set to 352×288, a maximum size of a coding unit is set to 16, and a maximum depth is set to 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are increased to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be more precisely expressed.

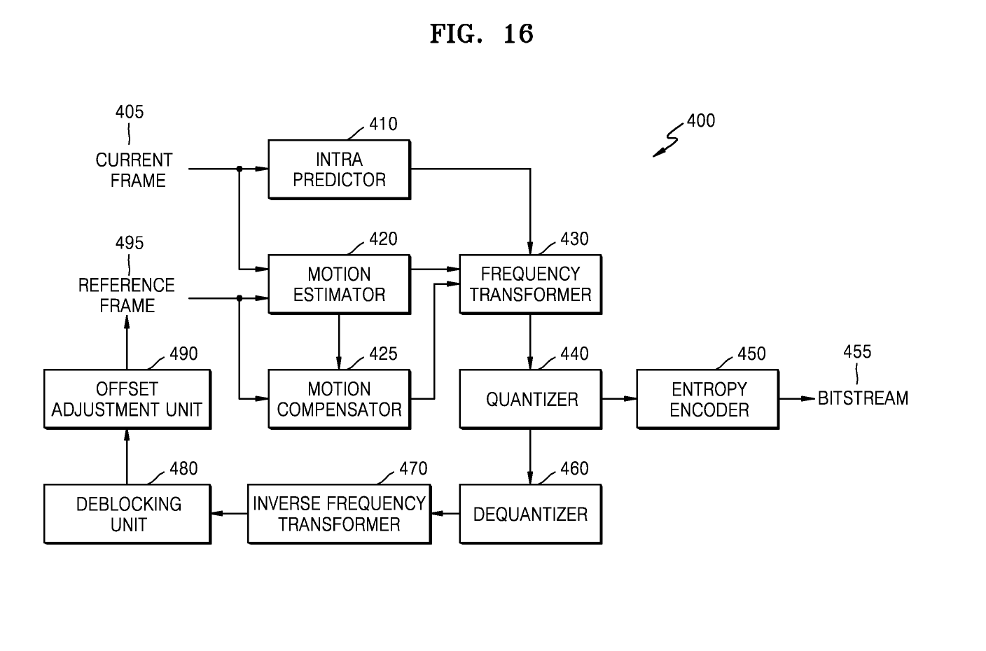

FIG. 16 is a block diagram of an image encoder 400 based on coding units, according to an embodiment of the present invention.

The image encoder 400 according to an embodiment performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 perform inter estimation and motion compensation on coding units in an inter mode from among the current frame 405 by using the current frame 405 and a reference frame 495.

Data output from the intra predictor 410, the motion estimator 420, and the motion compensator 425 is output as a quantized transformation coefficient through a frequency transformer 430 and a quantizer 440. The quantized transformation coefficient is restored as data in a spatial domain through an inverse quantizer 460 and an inverse frequency transformer 470, and the restored data in the spatial domain is output as the reference frame 495 after being post-processed through a deblocking unit 480 and an offset adjustment unit 490. The quantized transformation coefficient may be output as a bitstream 455 through an entropy encoder 450.

In order for the image encoder 400 to be applied in the video encoding apparatus 100 according to an embodiment, all elements of the image encoder 400, i.e., the intra predictor 410, the motion estimator 420, the motion compensator 425, the frequency transformer 430, the quantizer 440, the entropy encoder 450, the inverse quantizer 460, the inverse frequency transformer 470, the deblocking unit 480, and the offset adjustment unit 490 have to perform operations based on each coding unit from among coding units having a tree structure while considering the maximum depth of each maximum coding unit.

Specifically, the intra predictor 410, the motion estimator 420, and the motion compensator 425 have to determine partitions and a prediction mode of each coding unit from among the coding units having the tree structure while considering the maximum size and the maximum depth of a current maximum coding unit, and the frequency transformer 430 has to determine the size of the transformation unit in each coding unit from among the coding units having the tree structure.

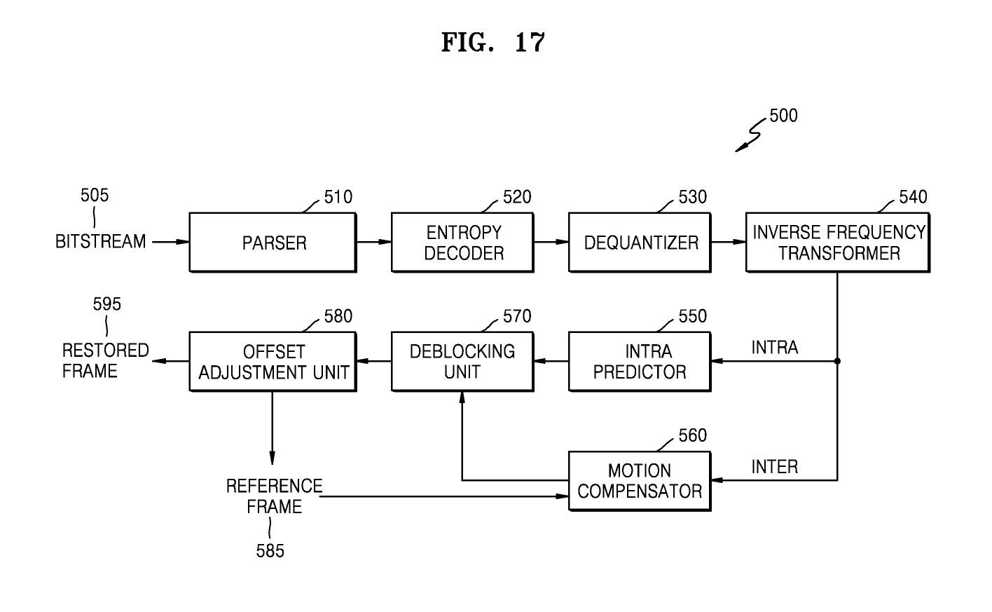

FIG. 17 is a block diagram of an image decoder 500 based on coding units, according to an embodiment of the present invention.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse frequency transformer 540.

An intra predictor 550 performs intra prediction on coding units in an intra mode with respect to the image data in the spatial domain, and a motion compensator 560 performs motion compensation on coding units in an inter mode by using a reference frame 585.

The data in the spatial domain, which passed through the intra predictor 550 and the motion compensator 560, may be output as a restored frame 595 after being post-processed through a deblocking unit 570 and an offset adjustment unit 580. Also, the data, which is post-processed through the deblocking unit 570 and the offset adjustment unit 580, may be output as the reference frame 585.

In order to decode the image data in the image data decoder 230 of the video decoding apparatus 200, the image decoder 500 may perform operations that are performed after operations of the parser 510 are performed.

In order for the image decoder 500 to be applied in the video decoding apparatus 200 according to an embodiment, all elements of the image decoder 500, i.e., the parser 510, the entropy decoder 520, the inverse quantizer 530, the inverse frequency transformer 540, the intra predictor 550, the motion compensator 560, the deblocking unit 570, and the offset adjustment unit 580 have to perform operations based on coding units having a tree structure for each maximum coding unit.

Specifically, the intra predictor 550 and the motion compensator 560 have to determine partitions and a prediction mode for each of the coding units having the tree structure, and the inverse frequency transformer 540 has to determine a size of a transformation unit for each coding unit.

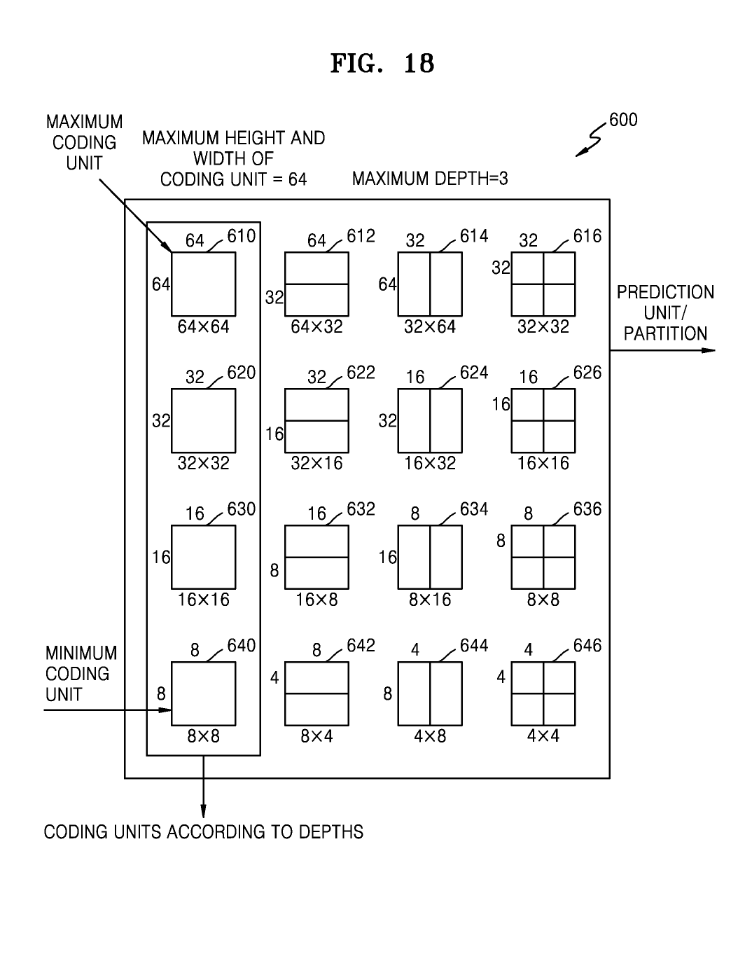

FIG. 18 is a diagram illustrating coding units according to depths and partitions, according to an embodiment of the present invention.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the maximum size of the coding unit which is previously set.

In a hierarchical structure 600 of coding units according to an embodiment, the maximum height and the maximum width of the coding units are each 64, and the maximum depth is 3. Since a depth increases along a vertical axis of the hierarchical structure 600 of the coding units according to an embodiment, a height and a width of the deeper coding unit are each split. Also, a prediction unit and partitions, which are bases for prediction encoding of each deeper coding unit, are shown along a horizontal axis of the hierarchical structure 600 of the coding units.

In other words, a coding unit 610 is a maximum coding unit in the hierarchical structure 600 of the coding units, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having the size of 8×8 and the depth of 3 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the coding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

Finally, the coding unit 640 having the size of 8×8 and the depth of 3 is the minimum coding unit and a coding unit of a lowermost depth.

In order to determine a coded depth of the maximum coding unit 610, the coding unit determiner 120 of the video encoding apparatus 100 according to an embodiment has to perform encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 have to be each encoded.

In order to perform encoding according to each depth, a representative encoding error that is a least encoding error in the corresponding depth may be selected by performing encoding for each prediction unit in the deeper coding units, along the horizontal axis of the hierarchical structure 600 of the coding units. Alternatively, the least encoding error may be searched for by comparing representative encoding errors according to depths by performing encoding for each depth as the depth increases along the vertical axis of the hierarchical structure 600 of the coding units. A depth and a partition having the least encoding error in the maximum coding unit 610 may be selected as the coded depth and a partition type of the maximum coding unit 610.

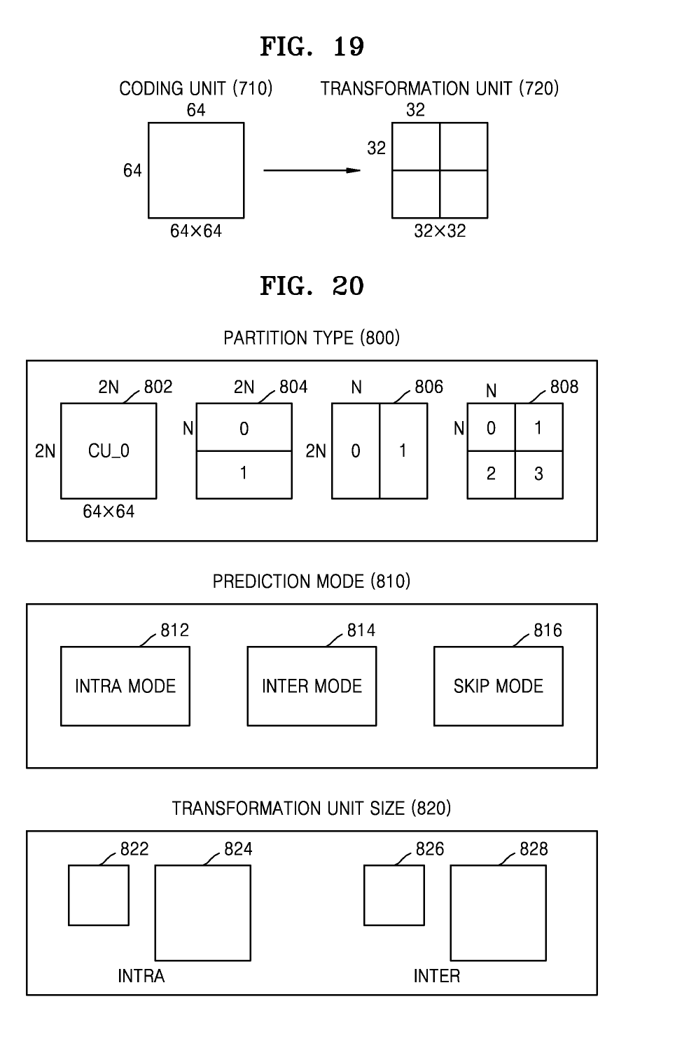

FIG. 19 is a diagram for describing a relationship between a coding unit 710 and transformation units 720, according to an embodiment of the present invention.

The video encoding apparatus 100 according to an embodiment or the video decoding apparatus 200 according to an embodiment encodes or decodes an image according to coding units having sizes smaller than or equal to a maximum coding unit for each maximum coding unit. Sizes of transformation units for frequency transformation during encoding may be selected based on data units that are not larger than a corresponding coding unit.

For example, in the video encoding apparatus 100 according to an embodiment or the video decoding apparatus 200 according to an embodiment, if a size of the current coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having a least error may be selected.

FIG. 20 is a diagram for describing encoding information of coding units corresponding to a coded depth, according to an embodiment of the present invention.

The output unit 130 of the video encoding apparatus 100 according to an embodiment may encode and transmit information 800 about a partition type, information 810 about a prediction mode, and information 820 about a size of a transformation unit for each coding unit corresponding to a coded depth, as information about an encoding mode.

The information 800 about the partition type indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type of the current coding unit is set to indicate one of the partition 804 having a size of 2N×N, the partition 806 having a size of N×2N, and the partition 808 having a size of N×N

The information 810 about the prediction mode indicates a prediction mode of each partition. For example, the information 810 about the prediction mode may indicate a mode of prediction encoding performed on a partition indicated by the information 800, i.e., an intra mode 812, an inter mode 814, or a skip mode 816.

Also, the information 820 about the size of the transformation unit indicates a transformation unit to be based on when frequency transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 according to an embodiment may extract and use the information 800 about the partition type, the information 810 about the prediction mode, and the information 820 about the size of the transformation unit for decoding according to each deeper coding unit

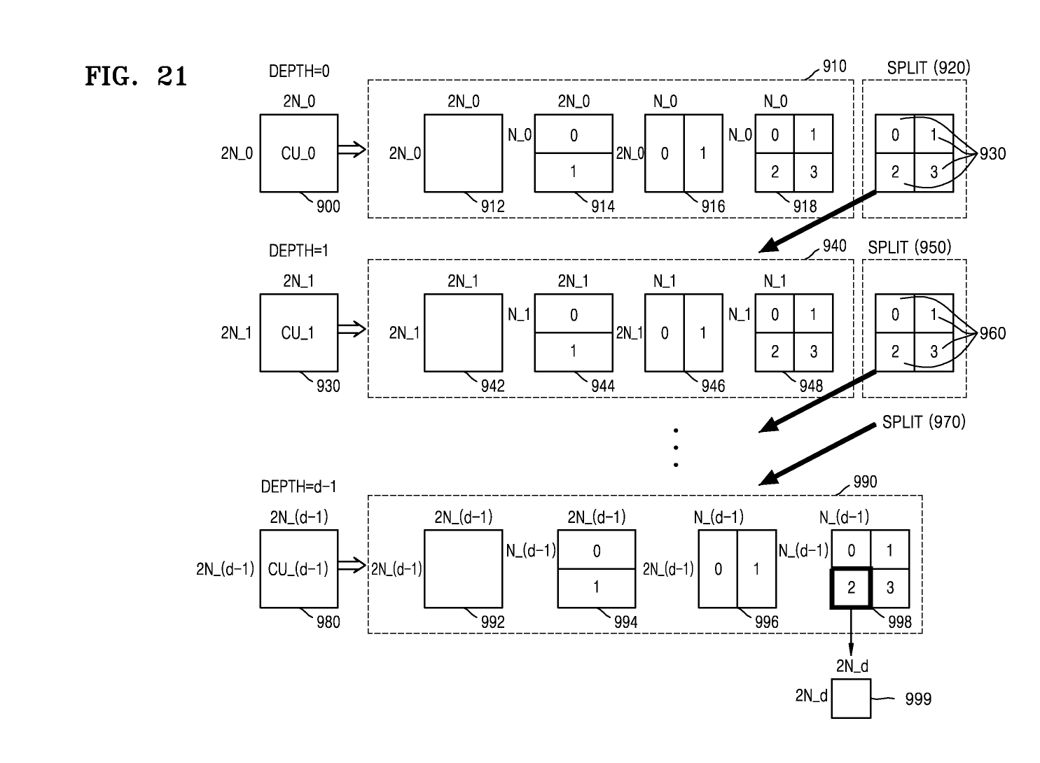

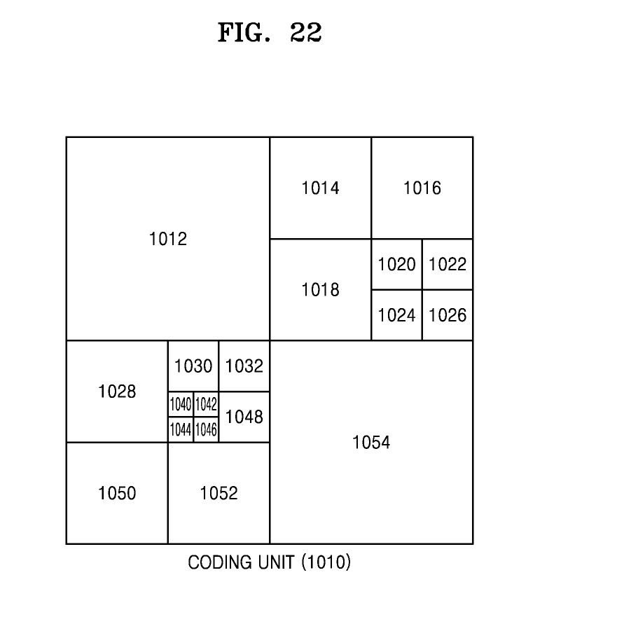

FIG. 21 is a diagram of coding units according to depths according to an embodiment of the present invention.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding has to be repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode may be performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may be no longer split to a lower depth.

If the encoding error is the smallest in the partition type 918 having the size of N_{—}0×N_{—}0, a depth may be changed from 0 to 1 to split the partition type 918 in operation 920, and encoding may be repeatedly performed on coding units 930 having a depth of 2 and a size of N_{—}0×N_{—}0 to search for a least encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948 having the size of N_{—}1 ×N_{—}1, a depth may be changed from 1 to 2 to split the partition type 948 in operation 950, and encoding may be repeatedly performed on coding units 960, which have a depth of 2 and a size of N_{—}2×N_{—}2 to search for a least encoding error.

When a maximum depth is d, split information according to each depth may be set until a depth becomes d-1, and split information may be set until a depth becomes d-2. In other words, when encoding is performed until the depth is d-1 after a coding unit corresponding to a depth of d-2 is split in operation 970, a prediction unit 990 for prediction encoding a coding unit 980 having a depth of d-1 and a size of 2N_(d-1)×2N_(d-1) may include partitions of a partition type 992 having a size of 2N_(d-1)×2N_(d-1), a partition type 994 having a size of 2N_(d-1)×N_(d-1), a partition type 996 having a size of N_(d-1)×2N_(d-1), and a partition type 998 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types 992 through 998 to search for a partition type having a least encoding error.

Even when the partition type 998 having the size of N_(d-1)×N_(d-1) has the least encoding error, since a maximum depth is d, a coding unit CU_(d-1) having a depth of d-1 may be no longer split to a lower depth, a coded depth for a current maximum coding unit 900 may be determined to be d-1, and a partition type of the current maximum coding unit 900 may be determined to be N_(d-1)×N_(d-1). Also, since the maximum depth is d, split information for a coding unit 952 having a depth of d-1 is not set.

A data unit 999 may be referred to as a ‘minimum unit’ for the current maximum coding unit. A minimum unit according to an embodiment may be a rectangular data unit obtained by splitting a minimum coding unit having a lowermost coded depth by 4. By performing the encoding repeatedly, the video encoding apparatus 100 may select a depth having a least encoding error by comparing encoding errors according to depths of the coding unit 900 to determine a coded depth, and may set a corresponding partition type and a prediction mode as an encoding mode of the coded depth.

As such, the least encoding errors according to depths are compared in all of the depths of 0, 1, . . . , d, and a depth having the least encoding error may be determined as a coded depth. The coded depth, the partition type of the prediction unit, and the prediction mode may be encoded and transmitted as information about an encoding mode. Also, since a coding unit has to be split from a depth of 0 to the coded depth, only split information of the coded depth has to be set to 0, and split information of depths excluding the coded depth has to be set to 1.

The image data and encoding information extractor 220 of the video decoding apparatus 200 according to an embodiment may extract and use the information about the coded depth and the prediction unit of the coding unit 900 to decode the coding unit 912. The video decoding apparatus 200 according to an embodiment may determine a depth, in which split information is 0, as a coded depth by using split information according to depths, and may use information about an encoding mode of the corresponding depth for decoding.

FIGS. 22 through 24 are diagrams for describing a relationship between coding units 1010, prediction units 1060, and frequency transformation units 1070, according to an embodiment of the present invention.

The coding units 1010 are coding units corresponding to coded depths determined by the video encoding apparatus 100 according to an embodiment, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partition types in the partitions 1014, 1022, 1050, and 1054 have a size of 2N×N, partition types in the partitions 1016, 1048, and 1052 have a size of N×2N, and a partition type of the is partition 1032 has a size of N×N. Prediction units and partitions of the coding units 1010 are smaller than or equal to each coding unit.

Frequency transformation or inverse frequency transformation is performed on image data of the transformation unit 1052 in the transformation units 1070 in a data unit that is smaller than the transformation unit 1052. Also, the transformation units 1014, 1016, 1022, 1032, 1048, 1050, and 1052 in the transformation units 1070 are different from those in the prediction units 1060 in terms of sizes or shapes. In other words, the video encoding apparatus 100 according to an embodiment and the video decoding apparatus 200 according to an embodiment may perform intra prediction/motion estimation/motion compensation, and frequency transformation/inverse frequency transformation individually on a data unit even in the same coding unit.

Accordingly, encoding may be recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an embodiment and the video decoding apparatus 200 according to an embodiment.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding Units |
| (Only | N × N | nR × 2N | | N/2 × N/2 | having Lower |
| 2N × 2N) | | | | (Asymmetrical | Depth of d + 1 |
| | | | | Type) | |

The output unit 130 of the video encoding apparatus 100 according to an embodiment may output the encoding information about the coding units having the tree structure, and the image data and encoding information extractor 220 of the video decoding apparatus 200 according to an embodiment may extract the encoding information about the coding units having the tree structure from a received bitstream.

Split information indicates whether a current coding unit is split into coding units of a lower depth. If split information of a current depth d is 0, a depth, in which a current coding unit is no longer split to a lower depth, is a coded depth, and thus information about a partition type, a prediction mode, and a size of a transformation unit may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD are respectively obtained by splitting the height of the prediction unit in 1:3 and 3:1, and the asymmetrical partition types having the sizes of nL×2N and nR×2N are respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit is set to 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be set to N×N, and if the partition type of the current coding unit is an asymmetrical partition type, the size of the transformation unit may be set to N/2×N/2.

The encoding information about coding units having a tree structure, according to an embodiment, may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth may be determined by using encoding information of a data unit, and thus a distribution of coded depths in a maximum coding unit may be determined.

Accordingly, if a current coding unit is predicted by referring to adjacent data units, encoding information of data units in deeper coding units adjacent to the current coding unit may be directly referred to and used.

Alternatively, if a current coding unit is prediction encoded by referring to neighboring data units, data units adjacent to the current coding unit in deeper coding units may be searched for by using encoded information of the data units, and the searched adjacent coding units may be referred to for prediction encoding the current coding unit.

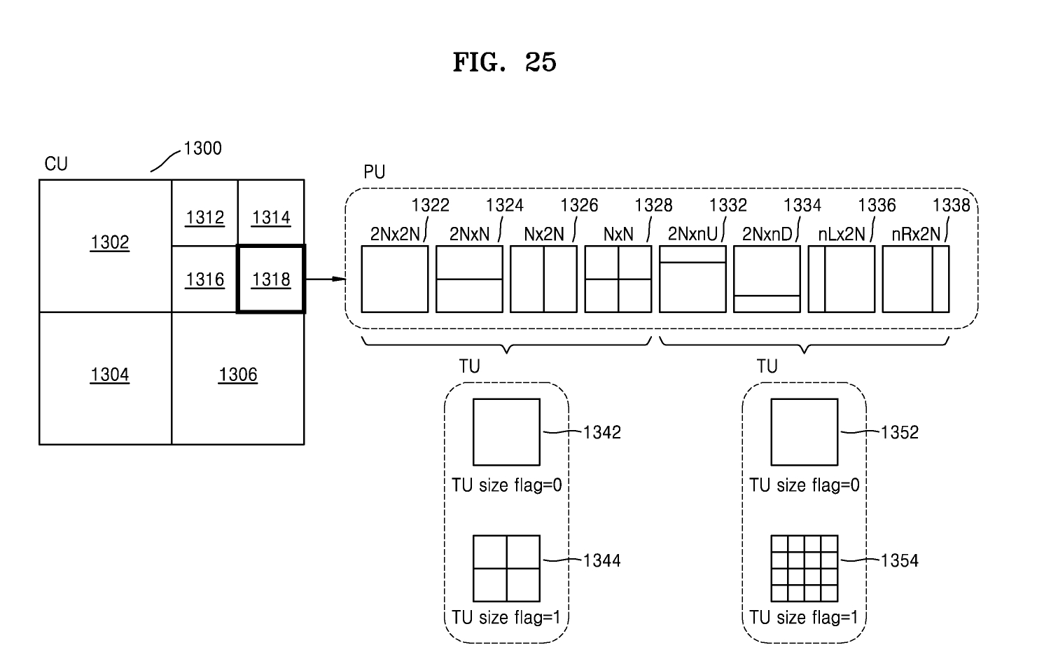

FIG. 25 is a diagram for describing a relationship between a coding unit, a prediction unit, and a transformation unit, according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU (Transformation Unit)size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 20, the TU size flag is a flag having a value or 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an exemplary embodiment, together with a maximum size and minimum size of the transformation unit. According to an exemplary embodiment, the video encoding apparatus 100 is capable of encoding maximum transformation unit size information, minimum transformation unit size information, and a maximum TU size flag. A result of encoding the maximum transformation unit size information, the minimum transformation unit size information, and the maximum TU size flag may be inserted into an SPS. According to an exemplary embodiment, the video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max (MinTransformSize, RootTuSize/(2̂MaxTransformSizelndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizelndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizelndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize, PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize, PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present invention is not limited thereto.

The maximum coding unit including the coding units having the tree structure described with reference to FIGS. 13 through 25 above is variously named as a coding block tree, a block tree, a root block tree, a coding tree, a coding root, or a tree trunk.

The embodiments of according to the present invention may be written as computer programs and may be implemented in general-use digital computers that execute the programs by using a computer-readable recording medium. Examples of the computer-readable recording medium include magnetic storage media (e.g., a read-only memory (ROM), a floppy disc, and a hard disc), optically readable media (e.g., a compact disc-read only memory (CD-ROM) and a digital versatile disc (DVD)), and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. A multilayer video encoding method comprising:
encoding an image sequence of each of a plurality of layers constituting multilayer video by using inter layer prediction;
determining a reference layer referred to by the image sequence of each layer based on a result of the encoding;
adding reference layer information of each layer to a first data unit comprising information commonly applied to the image sequence included in the multilayer video; and
when a reference layer referred to by the image sequence of each layer is changed at a predetermined point, adding change information of the reference layer to a second data unit.

2. The multilayer video encoding method of claim 1,
wherein the first data unit is a video parameter set (VPS) network adaptive layer (NAL) unit comprising VPS information, and
wherein the second data unit is a supplemental enhancement information (SEI) message NAL unit.

3. The multilayer video encoding method of claim 1, wherein reference layer information of each layer included in the first data unit is information regarding a reference layer referred to by pictures included in the image sequence of each layer, and reference layer information of each layer included in the second data unit is information regarding a reference layer referred to by pictures included in the image sequence after the predetermined point.

4. The multilayer video encoding method of claim 3, wherein the reference layer information of each layer included in the first data unit is flag information indicating whether to include a picture referring to another layer for each layer, and
wherein the reference layer information of each layer included in the second data unit comprises a reference layer index referred to by the pictures included in the image sequence after the predetermined point.

5. The multilayer video encoding method of claim 4,
wherein, when the number of a multilayer is m(, the flag information is direct_dependency_flag[i][j] indicating whether a picture referring to a picture included in an image sequence of a jth (where j is 0 or an integer less than i) layer exists among pictures included in an image sequence of an ith (where i is an integer from 1 to (m-1)) layer, and
wherein the reference layer index is ref_layer_id[i] indicating a reference layer index referred to by pictures included in an image sequence of the ith layer after the predetermined point.

6. The multilayer video encoding method of claim 1, wherein reference layer information of each layer included in the first data unit is information regarding a reference layer referred to by pictures included in the image sequence of each layer, and reference layer information of each layer included in the second data unit is flag information indicating whether the reference layer referred to by the pictures included in the image sequence of each layer determined based on the reference layer information added to the first data unit is continuously referred to by pictures included in the image sequence after the predetermined point.

7. A multilayer video encoding apparatus comprising:
a video encoder for encoding an image sequence of each of a plurality of layers constituting multilayer video by using inter layer prediction; and
an output unit for determining a reference layer referred to by the image sequence of each layer based on a result of the encoding, adding reference layer information of each layer to a first data unit comprising information commonly applied to the image sequence included in the multilayer video, and, when a reference layer referred to by the image sequence of each layer is changed at a predetermined point, adding change information of the reference layer to a second data unit.

8. A multilayer video decoding method comprising:
obtaining reference layer information of each of a plurality of layers from a first data unit comprising information commonly applied to an image sequence included in multilayer video;
determining a reference layer referred to by the image sequence of each layer based on the reference layer information of each layer;
obtaining a second data unit comprising change information of the reference layer referred to by the image sequence of each layer; and
changing the reference layer referred to by the image sequence of each layer decoded after the second data unit based on the change information of the reference layer.

9. The multi-view video decoding method of claim 8,
wherein the first data unit is a video parameter set (VPS) network adaptive layer (NAL) unit comprising VPS information, and
wherein the second data unit is a supplemental enhancement information (SEI) message NAL unit.

10. The multi-view video decoding method of claim 8, wherein reference layer information of each layer included in the first data unit is information regarding a reference layer referred to by pictures included in the image sequence of each layer, and reference layer information of each layer included in the second data unit is information regarding a reference layer referred to by pictures included in the image sequence of each layer decoded after the second data unit.

11. The multi-view video decoding method of claim 10,
wherein the reference layer information of each layer included in the first data unit is flag information indicating whether to include a picture referring to another layer for each layer, and
wherein the reference layer information of each layer included in the second data unit comprises a reference layer index referred to by the pictures included in the image sequence of each layer decoded after the second data unit.

12. The multi-view video decoding method of claim 11, wherein, when the number of a multilayer is m, the flag information is direct_dependency_flag[i][j] indicating whether a picture referring to a picture included in an image sequence of a jth (where j is 0 or an integer less than i) layer exists among pictures included in an image sequence of an ith (where i is an integer from 1 to (m-1)) layer, and
wherein the reference layer index is ref_layer_id[i] indicating a reference layer index referred to by pictures included in an image sequence of the ith layer decoded after the second data unit.

13. The multi-view video decoding method of claim 8, wherein reference layer information of each layer included in the first data unit is information regarding a reference layer referred to by pictures included in the image sequence of each layer, and reference layer information of each layer included in the second data unit is flag information indicating whether the reference layer referred to by the pictures included in the image sequence of each layer determined based on the reference layer information added to the first data unit is continuously referred to by pictures included in the image sequence decoded after the second data unit.

14. The multi-view video decoding method of claim 8, further comprising:
obtaining change information of a reference layer referred to by a random access point (RAP) picture from the second data unit; and
obtaining change information of a reference layer referred to by a non-RAP picture.

15. A multilayer video decoding apparatus comprising:
a receiver for obtaining reference layer information of each layer from a first data unit comprising information commonly applied to an image sequence included in multilayer video and obtaining a second data unit comprising change information of the reference layer referred to by the image sequence of each layer; and
a video decoder for determining a reference layer referred to by the image sequence of each layer based on the reference layer information of each layer, and changing the reference layer referred to by the image sequence of each layer decoded after the second data unit based on the change information of the reference layer.
